(19) United States
(12) Patent Application Publication
(10) Pub. No.: US 2018/0087435 A1
(43) Pub. Date: Mar. 29, 2018

(54) CYLINDER COOLING SYSTEM

(71) Applicant: James D. Richards, III, South Burlington, VT (US)

(72) Inventor: James D. Richards, III, South Burlington, VT (US)

(73) Assignee: Aerodyme Corporation, South Burlington, VT (US)

(21) Appl. No.: 15/717,153

(22) Filed: Sep. 27, 2017

Related U.S. Application Data
(60) Provisional application No. 62/400,158, filed on Sep. 27, 2016.

(51) Int. Cl. F01P 1/02; F02F 1/06; F02F 1/34; B64D 33/08

(52) U.S. Cl. CPC F01P 1/02; B64D 33/08; F02F 1/34; F02F 1/065

(57) ABSTRACT

A cylinder cooling system for aircraft engines is disclosed in which an air intake leads to multiple air chambers and the air is divided among the air chambers, which lead to the cylinders of the engine. In this way, approximately equal amounts of air of approximately the same temperature are able to pass over each cylinder, thereby providing more even cooling, resulting in more efficient engine performance. In addition, the cylinder cooling system is easily removable to access the engine spark plugs and fuel injectors for inspection and routine maintenance while not requiring the spark plug wiring or fuel lines to be disassembled in any way.

### CROSS-REFERENCE TO RELATED APPLICATIONS

This application claims priority to U.S. Provisional Patent Application No. 62/400,158, filed Sep. 27, 2016 and titled “Cylinder Cooling System,” which is hereby incorporated by reference in its entirety.

### FIELD OF INVENTION

The present invention generally relates to engine cooling systems. In particular, the present invention is directed to a cylinder cooling system that is especially suitable for aircraft engines.

### BACKGROUND OF THE INVENTION

Cylinder cooling for aircraft engines began by simply exposing the entire engine to the oncoming slipstream or partially enclosing the engine while leaving the cylinder heads protruding out through the cowling into the slipstream air, as exemplified by the original Piper Cub aircraft. More recently, more streamlined cowlings enclosed the entire aircraft engine, but with openings provided in the cowling to introduce cooling air to the engine, typically supplying air, at large, to the entire top or bottom half of the engine. Even more recently, in some cooling systems the air supply is divided between the left-hand and right-hand cylinder banks.

Air supply, at large, or even when divided left/right, does not evenly cool each cylinder, leading to “hot-spots” and causing loss of fuel economy and reduced engine life. Typically, aircraft have relied on an excessive supply of blast air through large openings in the front of the cowling to reach all the aircraft engine cylinders in a disorganized fashion. Cowling inlets are sized and configured such that the mass air flow in the engine compartment is sufficient to pass engine certification cooling tests. However, large inlets result in flow stagnation outside the cowling, before entry, and thus increase aerodynamic drag. Moreover, unbalanced air flow to the individual cylinders causes typical cylinder temperature spreads of 80° F. or more and additional fuel may be required, as coolant, to maintain the hottest cylinders within a desired operating temperature range. Therefore, combustion efficiency is lost due to higher than desirable fuel flow to the cylinders receiving less cooling air flow (which may be, depending on the engine configuration and other factors, the more aftward cylinders and/or cylinders that are positioned in between other cylinders) and lower than desirable fuel flow to the cylinders receiving more cooling air flow (which may be depending on the engine configuration and other factors, the more forward cylinders, for example.)

### SUMMARY OF THE DISCLOSURE

In an exemplary aspect, a device for directing air in order to provide cooling includes a first plenum and a second plenum, the first plenum and second plenum designed to be removably attached to opposite sides of an aircraft engine. Each of the first plenum and the second plenum include an air inlet designed and configured to divide incoming air into a plurality of airstreams, and a plurality of air chambers coupled to the air inlet, each of the plurality of air chambers configured to receive a respective one of the plurality of airstreams, wherein each of the plurality of air chambers is designed and configured to direct a respective received one of the plurality of airstreams to a different cylinder of the aircraft engine.

In another exemplary aspect, a cooling system includes an air inlet designed and configured to divide incoming air into a first airstream and a second airstream and a plenum connected to the air inlet and including a first air chamber into which the first airstream flows and a second air chamber into which the second airstream flows, wherein the first air chamber directs the first airstream to exit at a location that is further away from the air inlet in a downstream direction than a second location. The second air chamber directs the second airstream to exit at the second location that is downstream of the air inlet and closer to the air inlet than the first location.

In another exemplary aspect, a cylinder cooling system includes an air inlet designed and configured to divide incoming air into a plurality of airstreams coupled to a plenum that includes a plurality of air chambers, each of the plurality of air chambers having an entrance opening and an exit opening. The air inlet and the plurality of air chambers are configured such that a one of each of the plurality of airstreams enters the entrance opening of a corresponding one of each of the plurality of air chambers and the plenum is designed and configured to be secured on a portion of an aircraft engine having a plurality of cylinders. The plurality of cylinders are positioned from a forward most position to an aft most position and the plurality of air chambers and the plurality of cylinders are equal in number, and the exit opening of each of the plurality of air chambers is configured to deliver the one of the plurality of airstreams that entered that air chamber to a corresponding one of the plurality of cylinders.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a perspective view of an engine including a portion of a cylinder cooling system according to an embodiment of the present invention;

FIG. 2 is a perspective view of a cylinder cooling system in exploded relation to a portion of an aircraft cowling according to an embodiment of the present invention;

FIG. 3 is an exploded perspective view of a portion of a cylinder cooling system according to an embodiment of the present invention;

FIG. 4 is a top plan view of a portion of a cylinder cooling system according to an embodiment of the present invention;

FIG. 4A is a plan view along cutaway line A-A from FIG. 4;

FIG. 5 is a front view of a cylinder cooling system attached to an engine according to an embodiment of the present invention;

FIG. 6 is a perspective view of a cylinder cooling system attached to an engine according to an embodiment of the present invention; and

FIG. 7 shows a model of a modified cowling according to an embodiment of the present invention.

### DESCRIPTION OF THE DISCLOSURE

A cylinder cooling system according to the present disclosure achieves balanced air flow cylinder-by-cylinder by slicing the oncoming slipstream proximate to the cowling inlet(s) and ducting air to each individual cylinder. A cylinder cooling system according to the present disclosure can be sized and configured with a minimum aggregate height so as to allow for full containment of the cooling system within standard general aviation cowlings without major re-design. A cylinder cooling system according to the present disclosure can decrease the drag penalty caused by disorganized air intake into the cowling, reduce “hot-spots” in the engine, increase fuel economy, and allow aircraft to fly at faster average speeds. A cylinder cooling system according to the present disclosure can be disassembled such that common maintenance tasks are easily performed without requiring that the entire cooling system be removed. A cylinder cooling system according to the present disclosure can allow for smaller air intakes in the aircraft cowling thereby further reducing drag.

Embodiments of the cylinder cooling system disclosed herein can allow for easy removal of aggregate air plenum(s) to access the engine spark plugs and fuel injectors for inspection and routine maintenance while not requiring the spark plug wiring or fuel lines to be disassembled in any way. In exemplary embodiments, a cylinder cooling system as disclosed here includes a separate air connector, specifically sized and shaped for a specific airplane and engine model combination. In exemplary embodiments, tolerance of thermal expansion and contraction, and vibration isolation, are accomplished by fixed attachment of the cylinder cooling system plenum at the cylinder heads (outboard) while floating the plenum inboard attachments on rubber shock/slip mounts.

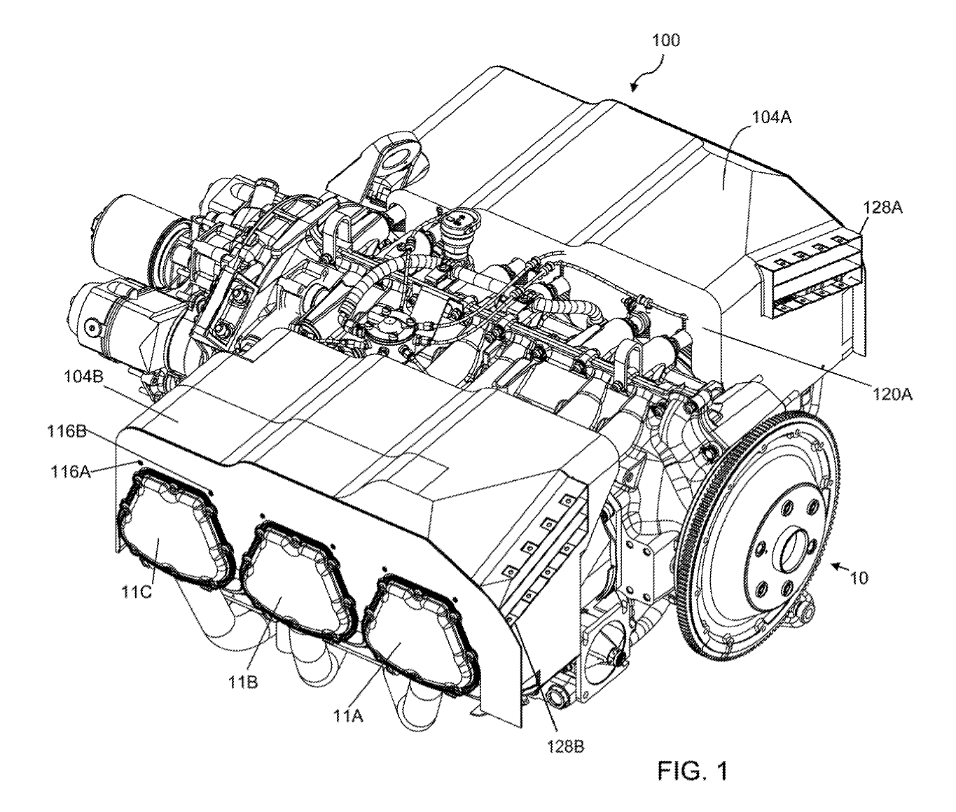

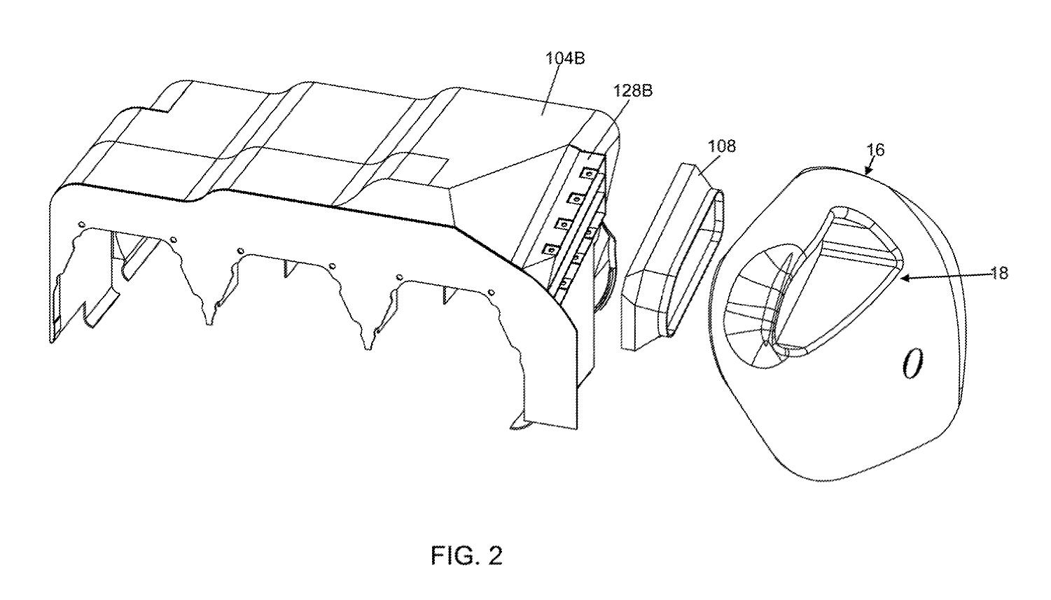

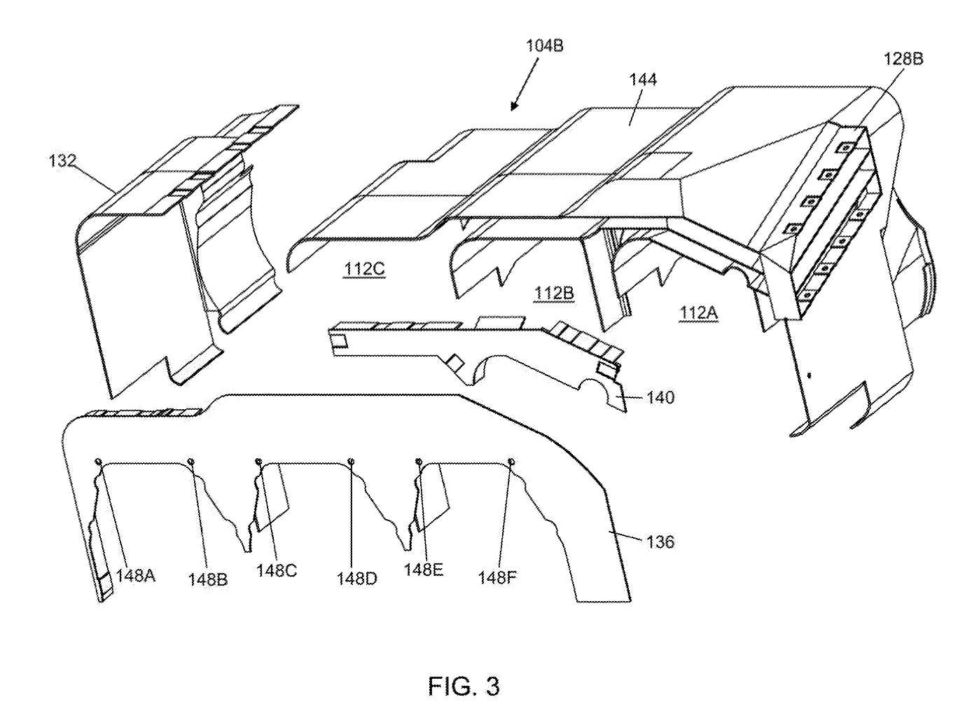

Turning now to the Figures, and particularly with reference to FIGS. 1-4, there is shown a cylinder cooling system 100 attached to an engine 10 according to an embodiment of the present disclosure. At a high level, cylinder cooling system 100 includes at least one plenum 104 and an air connector 108 (FIG. 2), with the plenum being divided into a plurality of air chambers 112 (e.g., air chambers 112A, 112B, 112C in FIG. 3), where the number of air chambers correspond to the number of cylinders to be fed cooling air. Although in the examples provided three cylinders are shown, it will be understood that the present invention is applicable for two cylinders (i.e., a four cylinder aircraft engine) or more than three cylinders in a line.

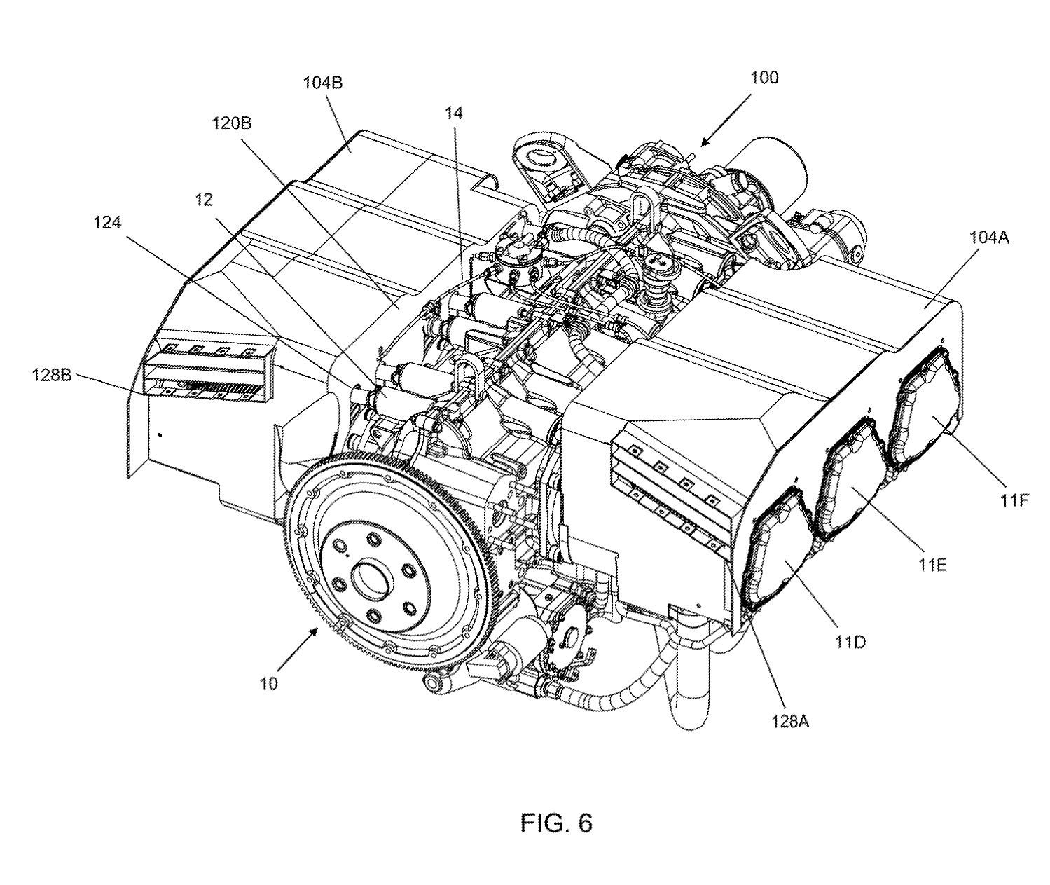

As shown in FIG. 1, cylinder cooling system 100 includes two plenums 104 (e.g., plenums 104A and 104B) that cover the right and left bank of engine cylinders, (e.g., right bank cylinders 11A-11C as well as left bank cylinders 11D-11F, which can be seen in FIG. 6) respectively. Each plenum 104 is sized and configured to mount to engine 10 at pre-established connection points 116 on the exterior sides of engine 10 using fasteners. While each plenum 104 is removably coupled to engine 10 at connection points 116 (e.g., 116A, 116B), an inside portion 120 of each plenum (i.e., a portion, 120A can be seen in FIGS. 1 and 120B can be seen in FIG. 6, that faces in toward the middle of engine 10) is allowed to “float” so as to allow for thermal expansion of the engine that occurs during use. As can be seen in FIG. 6, this floatation of plenums 104 can be achieved by including apertures in inside portion 120 to accommodate fuel lines 14 with sufficient tolerance to allow for thermal expansion. In addition, inside portion 120 may include apertures to accommodate push rod tubes 12 with sufficient tolerance to allow for thermal expansion and these apertures may have grommets 124 to secure inside portion 120 to push rod tubes 12 while still allowing inside portion 120 to float.

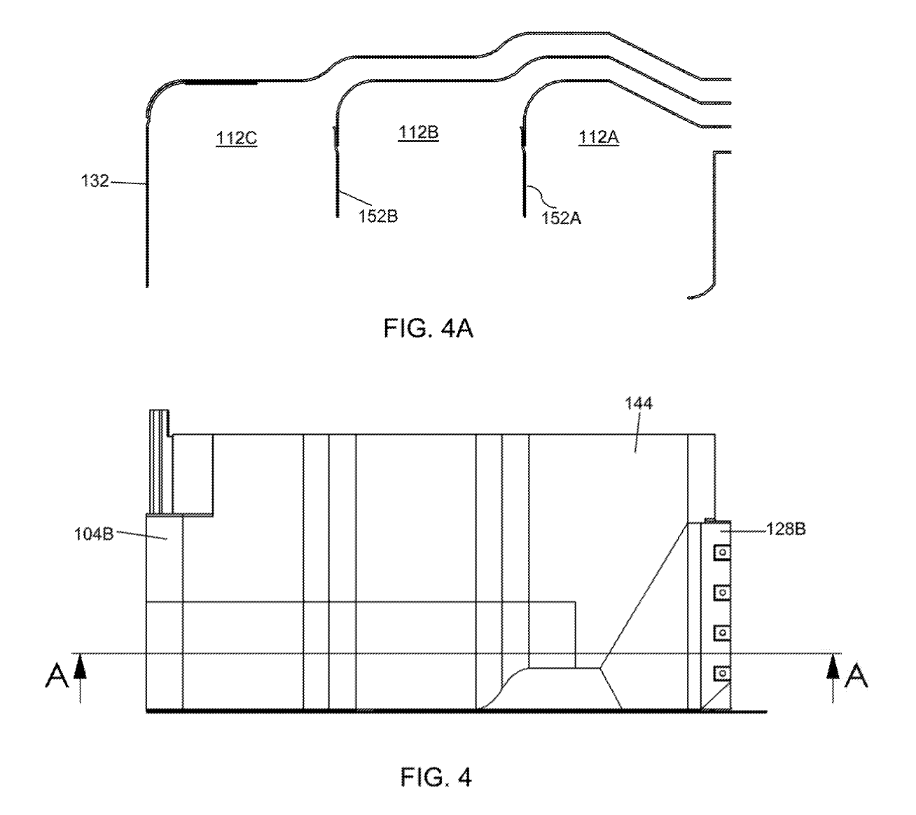

Plenum 104 also includes an air inlet 128 (e.g., 128A, 128B) that is sized and configured to split the incoming air supply into internal air chambers 112 that correspond to the number of cylinders used on a given side of the engine (discussed later with respect to FIGS. 3 and 4). The overall height of plenum 104 preferably does not extend significantly above the top of engine 10 so as to minimize or eliminate the need for cowling modifications.

Turning now to FIG. 2, there is shown plenum 104B, air connector 108, and a portion of aircraft cowling 16. Air connector 108 is sized and configured to attach to air inlet 128B and to air intake 18 that extends through aircraft cowling 16. When the aircraft is in forward motion, air enters through air intake 18, travels through air connector 108 and into air inlet 128B so as to cool engine 10 (not shown in FIG. 2).

FIG. 3 shows an exploded view of plenum 104B. At a high level, plenum 104 includes a rear portion 132, a side portion 136, a plate portion 140, and a top portion 144. Each of rear portion 132, side portion 136, plate portion 140, and a top portion 144 are releasably coupled together via fasteners. Rear portion 132 is sized and configured to couple to top portion 144 and side portion 136 and to surround the rear of engine 10 (not shown in FIG. 3). Rear portion 132 serves to direct air flow down and to prevent escape of cooling air before passing through the cylinder fins of the rearmost cylinder. Side portion 136 is designed and configured to be fit around the cylinders of engine 10 (as can best be seen in FIG. 1) and provides apertures 148 (e.g., 148A-148F) for coupling the side portion to the engine. Plate portion 140 facilitates the coupling of side portion 136 to top portion 144. The use of plate portion 140 assists in allowing for removal of top portion 144 and plate portion 140 when routine maintenance is to be done on engine 10 (such as spark plug or fuel intake maintenance), while allowing side portion 136 to remain coupled to engine 10 (thereby reducing time to disassemble cylinder cooling system 100).

Top portion 144 includes three air chambers 112 (e.g., 112A-112C), also shown from side view in FIG. 4A), which are designed and positioned relative to each other and air inlet 128 so as to maintain air coming in through air inlet 128 in three separate streams, one stream going into each air chamber 112. The incoming air thus divided then passes through each air chamber 112 and is delivered to the cylinders, each of which are in fluid communication with a respective one of air chambers 112. In a preferred embodiment, each air chamber 112 delivers about the same amount of cooling air to the cylinder in fluid communication with the air chamber. By providing substantially the same amount of air to each cylinder, control over the temperature of each cylinder is increased. As shown in FIG. 4A, each air chamber 112 includes a rear wall 152 (e.g., rear walls 152A-B, with the rear air chamber, e.g., 112C, having a rear wall formed by rear portion 132). Each rear wall 152 serves to direct cooling air down past each engine cylinder and then out through the bottom of the engine.

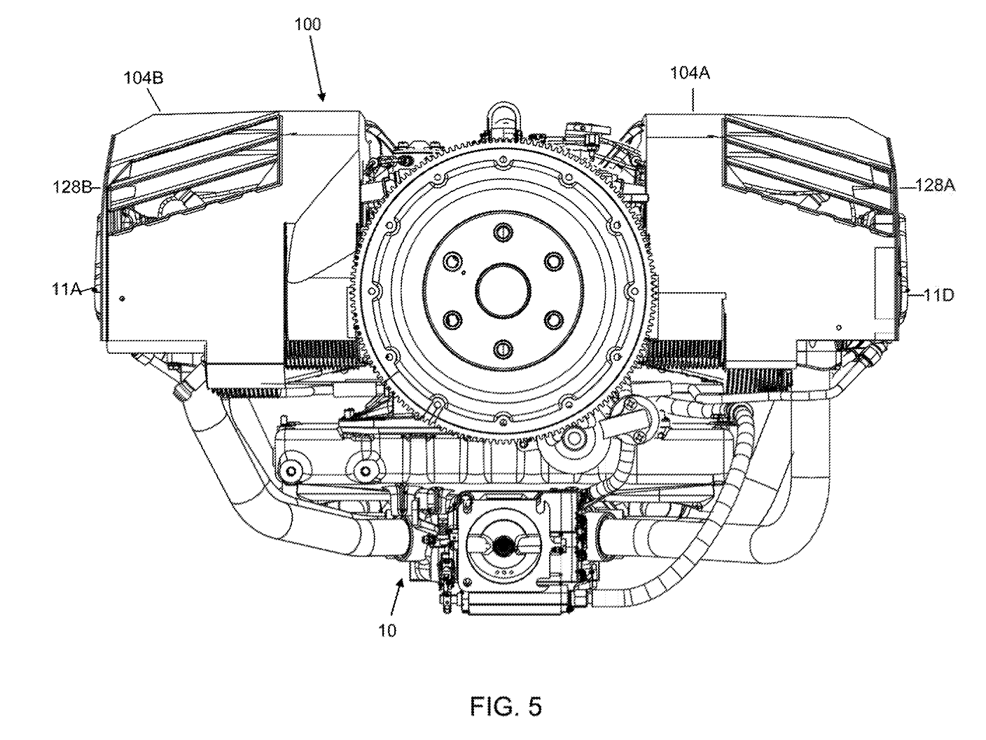

In use, air inlet 128 of the cylinder cooling system 100 slices incoming air (air coming in through air intake 18 when an aircraft is in motion) into a plurality of vertically-stacked air chambers 112 (as can best be seen in FIGS. 4A and 5) such that the air intended for each successively aftward cylinder may pass above the cylinders ahead of it. Stacking of the individual air chambers 112 to deliver cooling air, in turn, to each more aftward cylinder, by ducting over the top of the preceding cylinders is a preferred embodiment of plenum 104. In this manner, about the same amount of air arrives at each cylinder at about the same temperature, thereby providing even cooling for the cylinders regardless of the position of the cylinder with respect to the generally forward motion of the aircraft.

In a preferred embodiment, top portion 144 is removable in the upward direction without disassembly of any unrelated engine systems. In an exemplary embodiment, access to the engine spark plugs and fuel injectors is completed without any disassembly, or disconnection, of those subsystems.

Two mechanical formats of horizontally-opposed piston engines represent most general aviation piston aircraft designs, yet dozens of variations exist in cowling design. A cylinder cooling system according to the present disclosure comprehends broad application by separation of the design aspects entailed with interfacing to the engine versus interfacing to the cowling and provision of an application-specific air connector 108 to join the plenum 104 to the specific aircraft cowling 16.

As cylinder operating temperatures can easily reach 500° F. and appreciable thermal expansion and contraction can occur between various engine components, a cylinder cooling system as discussed herein employs fixed attachment at the cylinder heads but floating attachment at the engine core to prevent damage during expansion and contraction. Components of a cylinder cooling system as discussed herein are located proximate to the cylinder integral cooling fins where necessary but with no contact, or only light mechanical contact, to avoid degradation of the component due to high engine temperatures.

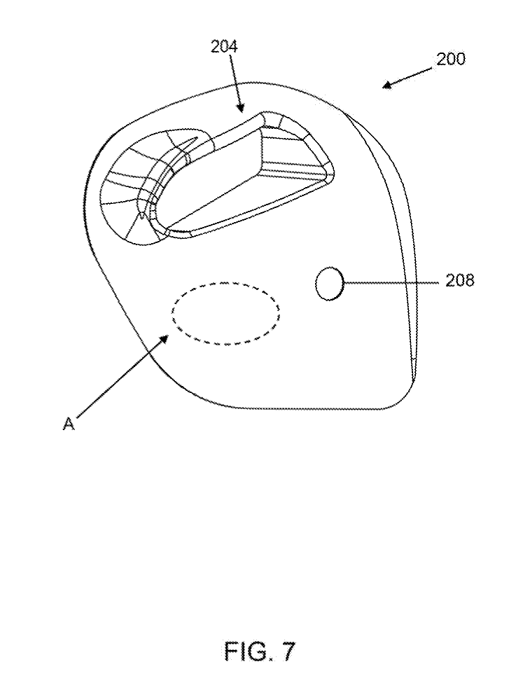

FIG. 7 shows an exemplary cowling 200 that has been modified to accommodate a cylinder cooling system, such as cylinder cooling system 100. Cowling 200 includes a new air intake 204 and includes an auxiliary access 208. As represented, the old air intake “A” has been covered over. In this embodiment, when cowling 200 is used with cylinder cooling system 100, new air intake 204 is fluidly coupled to plenum 104 via air connector 108, which can be been sized and configured to be suitable for this purpose.

In a preferred embodiment, cylinder cooling system 100 is made from thermoplastics using additive manufacturing techniques.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A device for directing air in order to provide cooling comprising:
a first plenum and a second plenum, the first plenum and the second plenum designed to be removably attached to opposite sides of an aircraft engine, each of the first plenum and the second plenum including:
an air inlet designed and configured to divide incoming air into a plurality of airstreams; and
a plurality of air chambers coupled to the air inlet, each of the plurality of air chambers configured to receive a respective one of the plurality of airstreams, wherein each of the plurality of air chambers is designed and configured to direct a respective received one of the plurality of airstreams to a different cylinder of the aircraft engine when the plenum is attached to the aircraft engine.

2. The device of claim 1 wherein the first plenum includes three or more air chambers and wherein the second plenum includes three or more air chambers.

3. The device of claim 1 wherein the first plenum includes an inside portion, the inside portion designed to be secured to the aircraft engine in a manner that allows for thermal expansion of the aircraft engine.

4. The device of claim 3 wherein the inside portion includes apertures with sufficient tolerance to accommodate fuel lines while allowing for thermal expansion of the aircraft engine and wherein the inside portion includes grommeted apertures to secure the inside portion to push rod tubes while allowing the inside portion to float to allow for thermal expansion of the aircraft engine.

5. The device of claim 1 further including a first air connector coupled to the air inlet of the first plenum and a second air connector coupled to the air inlet of the second plenum.

6. The device of claim 5 further including a first air intake coupled to the first air connector and a second air intake connector coupled to the second air connector.

7. The device of claim 6 further including a cowling with an auxiliary access.

8. The device of claim 1 wherein the first plenum does not extend significantly above the top of the aircraft engine when attached to the aircraft engine and wherein the second plenum does not extend significantly above the top of the aircraft engine when attached to the aircraft engine.

9. A cooling system comprising:
an air inlet designed and configured to divide incoming air into an upper airstream and a lower airstream; and
a plenum connected to the air inlet and including a first air chamber into which the upper airstream flows and a second air chamber into which the lower airstream flows, wherein the first air chamber directs the upper airstream to exit at a location that is further away from the air inlet in a downstream direction than a second location, and wherein the second air chamber directs the lower airstream to exit at the second location that is downstream of the air inlet and closer to the air inlet than the first location.

10. The cooling system of claim 9 wherein the air inlet, the first air chamber, and the second air chamber are designed and configured such that an approximately equal flow of air exits the first air chamber and the second air chamber at each of the first location and the second location.

11. A cylinder cooling system comprising:
an air inlet designed and configured to divide incoming air into a plurality of airstreams; and
a plenum including a plurality of air chambers, each of the plurality of air chambers having an entrance opening and an exit opening, wherein the air inlet and the plurality of air chambers are configured such that a one of each of the plurality of airstreams enters the entrance opening of a corresponding one of each of the plurality of air chambers, wherein the plenum is designed and configured to be secured on a portion of an aircraft engine having a plurality of cylinders, wherein the plurality of cylinders are positioned from a forward most position to an aft most position, wherein the plurality of air chambers and the plurality of cylinders are equal in number, and wherein the exit opening of each of the plurality of air chambers is configured to deliver the one of the plurality of airstreams that entered that air chamber to a corresponding one of the plurality of cylinders.

12. The cylinder cooling system of claim 11 wherein the plurality of air chambers are designed and configured such that an approximately equal airstream is delivered to each of the plurality of cylinders.

13. The cylinder cooling system of claim 11 wherein the plurality of airstreams are initially arranged vertically.

14. The cylinder cooling system of claim 11 wherein the plenum includes an inboard portion and wherein the inboard portion is designed to be secured to the aircraft engine in a manner that allows for thermal expansion of the aircraft engine.

15. The cylinder cooling system of claim 11 wherein the plurality of cylinders each include a cylinder head and wherein the plenum includes an outboard portion, the outboard portion designed and configured to have a fixed attachment at the cylinder heads.

16. The cylinder cooling system of claim 14 wherein the inboard portion includes apertures with sufficient tolerance to accommodate fuel lines while allowing for thermal expansion of the aircraft engine and wherein the inside portion includes grommeted apertures to secure the inside portion to push rod tubes while still allowing the inside portion to float to allow for thermal expansion of the aircraft engine.

17. The cylinder cooling system of claim 11 wherein the plenum is sized and configured to be removably mounted to the portion of the aircraft engine via connection points on the aircraft engine using fasteners.

18. The cylinder cooling system of claim 11 further including an air intake coupled to an air connector, wherein the air connector is coupled to the air inlet.
